(19) United States
(12) Patent Application Publication
(10) Pub. No.: US 2025/0066009 A1
(43) Pub. Date: Feb. 27, 2025

(54) Adjustable Gradient Tinting for Aircraft Windscreen

(71) Applicant: Textron Aviation Inc., Wichita, KS (US)

(72) Inventors: Michael Scott Robinson, Cheney, KS (US); Jonathan Lynn Headrick, Peck, KS (US)

(21) Appl. No.: 18/811,442

(22) Filed: Aug. 21, 2024

Related U.S. Application Data
(60) Provisional application No. 63/578,977, filed on Aug. 25, 2023.

(51) Int. Cl. B64C 1/14; G02F 1/163

(52) U.S. Cl. CPC B64C 1/1476; G02F 1/163

(57) ABSTRACT

An aircraft windscreen comprises a plurality of liquid crystal display (LCD) films positioned on or within various portions of the windscreen to define a corresponding plurality of zones. The opacity of the LCD films are individually and separately controllable by control circuitry in communication with user controls to allow a user to darken or lighten portions of the various LCD films to achieve a desired level of gradient tint in the defined zones to block external light, such as sunlight, from the aircraft.

### CROSS-REFERENCE TO RELATED APPLICATIONS

This application claims the benefit of U.S. Provisional Patent Application No. 63/578,977, filed Aug. 25, 2023, the disclosure of which is hereby incorporated herein in its entirety by reference.

### FIELD

The present invention relates generally to aircraft windscreens, and more specifically to aircraft windscreens and windows having adjustable gradient tinting.

### BACKGROUND

Unwanted sunlight entering aircraft through windscreens or windows can make it difficult for pilots to view display screens or instruments, can heat the cockpit or interior of the aircraft, and can otherwise distract from operation of the aircraft.

In order to alleviate those problems many aircraft are equipped with sun visors and sunshades that may be positioned to block or attenuate the incoming sunlight. Those visors and shades, however, take up valuable cockpit space even when not in use and in the stowed position, especially in smaller business and commercial aircraft. Furthermore, the visors and shades often cannot be physically positioned to adequately block the light, thus while they may alleviate the problem, they do not eliminate it.

In addition to physical sun visors and screens, tinted windows, windshields, and windscreens that provide attenuation or lessening of light levels are known in the art and are often used to lessen the brightness of sunlight or other light passing through the windscreen. For example, windscreens having a continuous tint level provide even shading across the entirety of the windscreen to reduce the amount of light entering the cockpit. And windscreens having graduated tinting—i.e., tinting that varies across the windscreen—are often used to provide greater shading at the uppermost portion of the windscreen and minimal shading at the lower portions of the windscreen to block light from the sun at its higher positions in the sky while providing relatively unimpeded viewing forward through the windscreen.

Windscreens employing electrochromic tinting—i.e., tinting that is controlled by electrical voltage and/or current—are also known in the art, allowing a user to turn on or turn off the tinting of the windscreen, often through control of a liquid crystal display (LCD) film layer embedded within the windscreen. However, known systems and methods of adjusting tinting of windscreens are typically directed to simple on/off configurations allowing a level tinting or shading of the entire windscreen to be enabled or disabled, or allowing a gradient tinting of the entire windscreen to be enabled or disabled.

### SUMMARY

This summary is provided to introduce a selection of concepts with respect to the claimed invention in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The present invention is directed to a system for providing adjustable gradient tinting for aircraft windscreens and windows. In one embodiment, the system comprises one or more liquid crystal display (LCD) films positioned on or within various portions of a windscreen or window of an aircraft, with the opacity of the LCD films individually electronically controllable and operable via user controls to allow a user to darken or lighten portions of the various LCD films to achieve a desired level of tint to block external light, such as sunlight, from the aircraft. In further embodiments, electrochromic material other than LCD film may be used.

In one embodiment, the LCD films comprise a gradient pattern in which one portion (e.g., a first edge) of the film has more light blocking elements and another portion (e.g., a second or opposite edge) has fewer light blocking elements, and such that the light blocking elements are arranged in a gradient pattern, with greater light blocking ability at one edge (e.g., an edge at the top of the windscreen) and lesser light blocking ability at the opposite edge (e.g., an edge at the bottom of the windscreen) so that the overall effect is a gradual decrease in the amount of light blocked from the top to the bottom of the windscreen. Control circuitry comprising LCD driver circuitry and user operable controls allow a user to darken or lighten the gradient tinting to achieve a desired level of tinting/light blocking.

In other embodiments, various portions of the windscreen (or window) may include separate LCD films so that various portions of the windscreen or window may be separately darkened. For example, if sunlight is entering from the port side of the windscreen, a user may darken that portion of the windscreen separately, without darkening other portions of the windscreen. Or, in that same scenario, users may individually darken separate windows on the port side of the aircraft as desired. In some embodiments, user controls may be individual switches or adjustable controls such as sliding or rotary potentiometers, in other embodiments, the user controls may be integrated into display screens or other equipment on the aircraft, in still further embodiments, infrared (IR), capacitive, motion sensing, or other controls may detect a user's hand gestures or other movements to control the LCD film so that, for example, a windscreen (or portion of a windscreen) may be darkened by a user making a swiping-down gesture or lightened by making a swiping-up gesture.

In one exemplary embodiment, the control circuitry may include preset or user-definable limits to prevent over-darkening of the LCD film to accommodate user preferences or regulations limiting the amount of allowable darkening or the amount of required open area in a windscreen or window (minimal view). In further embodiments, some portions of the windscreen may not include any LCD film and thus remain unaffected by the darkening or lightening of any other portions.

### BRIEF DESCRIPTION OF THE DRAWINGS

FIG. 1 is a diagrammatic view of a system for adjustable gradient tinting for an aircraft windscreen in accordance with an exemplary embodiment of the present invention.

FIG. 2 is a perspective view of an aircraft windscreen with adjustable gradient tinting implemented at a first level of tinting in accordance with an exemplary embodiment of the present invention.

FIG. 3 is a perspective view of the aircraft windscreen of FIG. 2 with adjustable gradient tinting implemented at a second level of tinting.

FIG. 4 is a perspective view of the aircraft windscreen of FIG. 2 implemented with multiple gradient tinting zones.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” “leftwardly,” “port”, “starboard”, “upper,” and “lower” may refer to the installed position of the item to which the reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

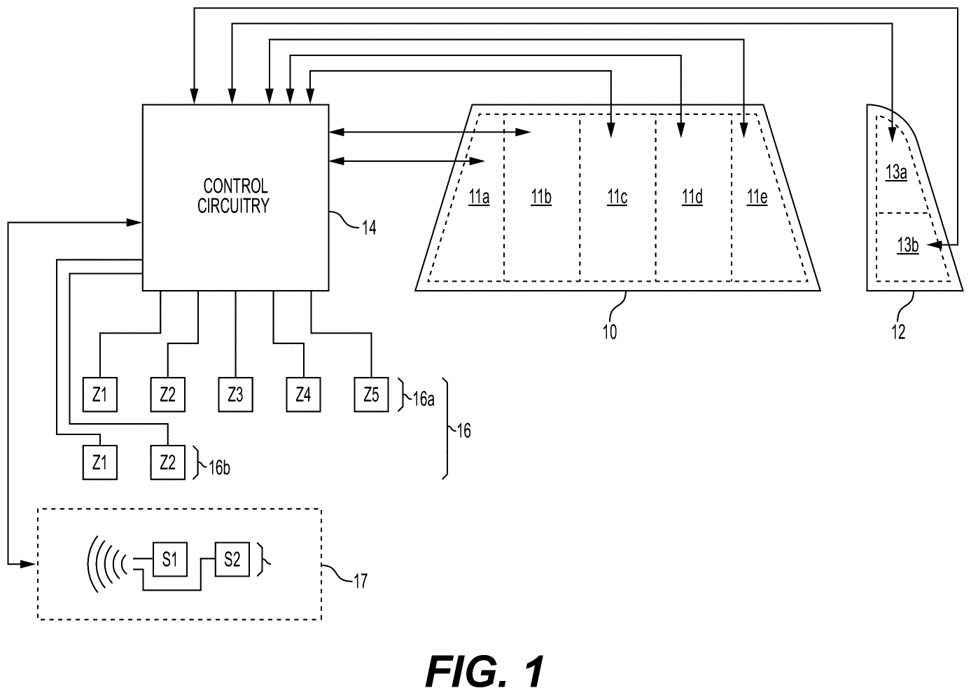

An aircraft windscreen with adjustable gradient tinting in accordance with exemplary embodiments of the present invention is shown in the figures. Referring first to FIG. 1, in one exemplary embodiment, the windscreen system generally comprises a windscreen 10, a window 12, and control circuitry 14 operable to control the various liquid crystal display (LCD) films (11a through 11e, 13a, 13b) embedded as a layer positioned within (or on) the windscreen 10 and the window 12.

As seen in FIG. 1, the LCD films are preferably configured and arranged to form a plurality of separate zones, each individually controllable as will be discussed in more detail below. As depicted in the embodiment of FIG. 1, the windscreen 10 comprises five separate LCD zones (11a, 11b, 11c, 11d, and 11e) and the window 12 comprises two separate LCD zones (13a and 13b). In other embodiments, the LCD films may comprise more or fewer zones across the windscreen 10. In some embodiments, a single LCD film may cover the windscreen 10, without separate zones. These and other embodiments are contemplated by the present invention.

In a preferred embodiment as depicted in FIG. 1, the opacity of each of the LCD films is individually electronically controllable and operable via user controls to allow a user to darken or lighten portions of the various LCD films to achieve a desired level of tint to block external light, such as sunlight, from the aircraft.

While the exemplary embodiments described herein are described and depicted as comprising LCD film, it should be understood that alternative embodiments of the invention may use various types of LCD technology or may use other types of electrochromic materials and technologies without departing from the scope of the present invention. For example, tinting and shading in accordance with the present invention may be accomplished using Suspended Particle Devices (SPD) technology, Polymer Dispersed Liquid Crystal (PDLC) technology, or any other electrochromic technology known in the art.

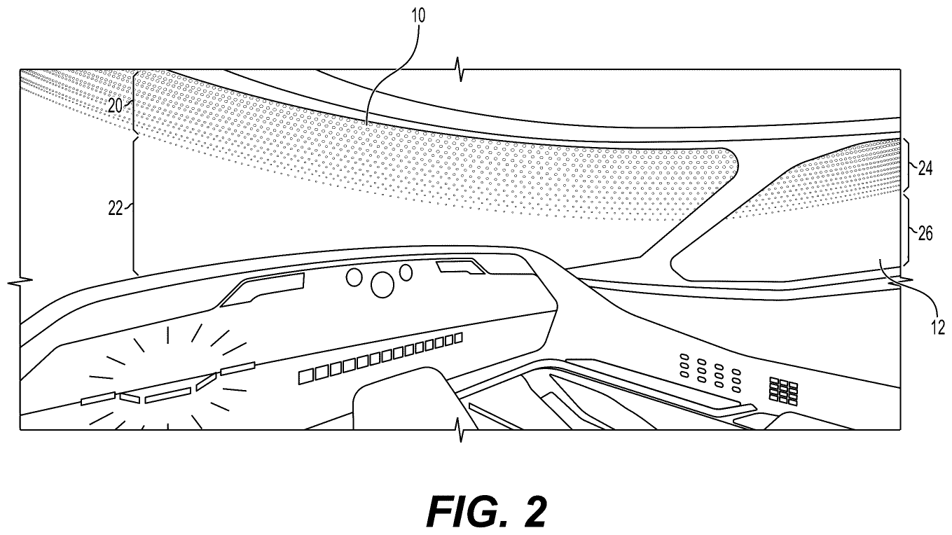

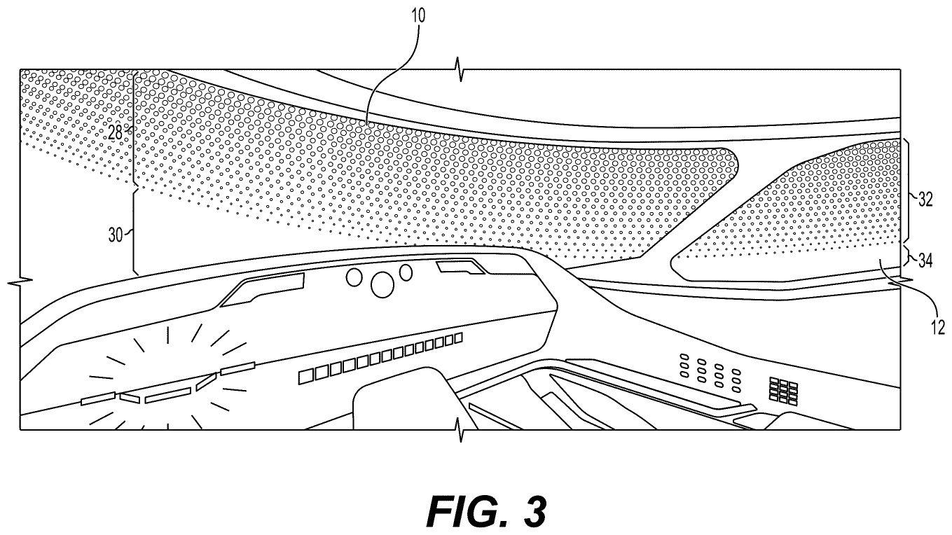

Looking to FIGS. 2 and 3 in conjunction with FIG. 1, in a preferred embodiment, each LCD film comprises a gradient pattern in which one portion (e.g., a first edge, such as an upper edge) of the film comprises a greater number of light blocking elements while another portion (e.g., a second edge, such as a lower edge) has a fewer number of light blocking elements, and such that the light blocking elements form a gradient pattern from top to bottom (and/or from bottom to top), with greater light blocking ability at one edge (e.g., an edge at the top of the windscreen) and lesser light blocking ability at the opposite edge (e.g., an edge at the bottom of the windscreen) so that the overall effect is a gradual decrease in the amount of light that may be blocked from the top to the bottom of the windscreen.

As described in more detail below, control circuitry comprising LCD driver circuitry and user operable controls thus allow a user to darken or lighten the gradient tinting to achieve a desired level of tinting/light blocking.

In some embodiments, as depicted in FIG. 1, various portions of the windscreen 10 (or window 12) may include separate LCD films so that various portions of the windscreen or window may be separately darkened. For example, if sunlight is entering from the port side of the windscreen, a user may darken that portion of the windscreen separately, without darkening other portions of the windscreen. Or, a user may individually darken separate windows 12 on either side of the aircraft as desired without affecting the tinting of the primary windscreen 10.

Control circuitry 14 is in electrical communication with the LCD film of each of the plurality of zones, with the control circuitry 14 operable to lighten or darken the LCD tinting elements within the respective zone to increase or decrease the amount of sunlight (or other external light) that is permitted to pass through the zone. A plurality of user actuated controls 16 in communication with the control circuitry allow users to separately control the tinting for each zone within the windscreen 10 and window 12 with controls 16a and 16b, respectively. Control circuitry 14 preferably includes one or more processors, microprocessors, controllers, and/or other logic circuitry operable to implement a user's desired settings in the opacity of the LCD film and to impose limits on the amount of opacity allowed.

Turning to FIGS. 2 and 3, exemplary implementation of gradient tinting of the LCD film is depicted on a windscreen and a window of an aircraft. As seen in FIG. 2, the gradient tinting at the top 20 of the windscreen comprises a series darkened areas that extend downwardly across the windscreen and window, with the darkness or opacity diminishing towards the middle and bottom 22 of the windscreen and window. Similarly, the darkened area at the top 24 of the window diminishes towards the middle and bottom 26 of the window. As described above with respect to FIG. 1, the dark areas are generated on an LCD film (or other electrochromic material) preferably embedded as a layer within the windscreen or window, with electrical signals from the control circuitry 14 dictating the opacity as controlled by a user.

Thus, as can be seen in comparing FIGS. 2 and 3, the darkness or level of tinting may be adjusted by increasing the level of opacity within a particular zone, or by increasing the overall effective opacity across the entire windscreen 10 and/or window 12.

For example, the shading or tinting 20 in FIG. 2 extends only partially downwardly from the top of the windscreen and window with a non-shaded portion 22 of the windscreen extending the rest of the way down the windscreen, as compared to the shading or tinting 28 in FIG. 3, where the LCD elements are spaced more closely together and extend more than halfway down the windscreen, with the lower portion 30 of the windscreen being essentially untinted.

Similarly, the tinting of the window in FIG. 3 extends downwardly more than halfway 32 on the window, with the lower portion 34 essentially untinted. Thus, the overall gradient tinting of the windscreen and window in FIG. 3 is greater than the level of tinting of the windscreen and window in FIG. 2. The level of tinting is adjustable by a user using zone controls in communication with the control circuitry as described above, and as will now be described in more detail. In one embodiment, the electrochromic or LCD film encompasses at least sixty percent of the windscreen.

Turning back to FIG. 1, the control circuitry 14 is in communication with the LCD films comprising zones 11a, 11b, 11c, 11d, and 11e of the windscreen 10, and with the LCD films comprising zones 13a and 13b of the window 12. Control circuitry preferably includes LCD driver circuitry along with power supply circuitry and user control circuitry to allow the control circuitry to adjust the tinting gradient of each LCD film according to a corresponding user input.

In the exemplary embodiment of FIG. 1, a separate user control is provided for each zone to allow a user to increase or decrease the tinting in the respective zone. For example, using windscreen controller Z1, a user may adjust the tinting of zone 11a of the windscreen (i.e., the first zone of the windscreen), and using windscreen controller Z2, a user may adjust the tinting of zone 11b, and so forth. Thus, a user may control the tinting of the various zones independently using the windscreen controllers 16a. Similarly, a user may control the tinting of the two zones 13a, 13b of the window 12 using the corresponding Z1 and Z2 window controllers 16b.

The user controls may be any type of switch, potentiometer, encoder, or other type of control device known in the art. For example, the controls may slide linearly or may rotate to allow a user to move the control between upper and lower stops. Or, the controls may be infinitely rotatable, without stops, with the control circuitry monitoring the direction of movement of the control and adjusting the tinting of the controlled zone correspondingly. In other embodiments the controls may comprise voice or sound actuated controls so that a user may speak commands to the control circuitry to actuate the desired gradient tinting. Preferably, the control circuitry includes preset and/or user-defined limits to prevent unauthorized or unallowed tinting configurations.

For example, as depicted in FIG. 2, center zone 11c may be restricted from having an opacity greater than 25 percent, in which case the user control would only allow adjustment up to that limit. The control circuitry also preferably monitors the overall opacity of all of the zones, and may likewise prevent over and/or under tinting of the windscreen and windows regardless of the individual user controls.

In some embodiments, the user controls may be individual switches or adjustable controls such as sliding or rotary potentiometers, in other embodiments, the user controls may be integrated into display screens or other equipment on the aircraft. In still further embodiments, the user controls may comprise infrared (IR), capacitive, motion sensing, or other controls that may detect a user's hand gestures or other movements to control the LCD film so that, for example, a windscreen (or portion of a windscreen, or a window) may be darkened by a user making a swiping-down gesture or lightened by making a swiping-up gesture.

In one exemplary embodiment, the control circuitry may include preset and/or user-definable limits to prevent over-darkening of the LCD film to accommodate user preferences or to comply with regulations limiting the amount of allowable darkening or the amount of required open area in a windscreen or window (i.e., a “minimal view” requirement). In further embodiments, some portions of the windscreen and/or windows may not include any LCD film and thus remain unaffected by the darkening or lightening of any other portions.

It should be understood that the zones as depicted in FIG. 1 are exemplary, and that other numbers of zones and configurations of zones are within the scope of the present invention. For example, in some embodiments, each zone depicted in FIGS. 1 (11a, 11b, 11c, 11d, and 11e) may be subdivided into further zones, such that each main zone may have an upper, a middle, and a lower subzone, with each of the subzones similarly controllable by the control circuitry and the user controls. Or, the zones may be configured horizontally across the windscreen, with upper, middle, and lower “stripes” of LCD film controllable by the user. These and other configurations and arrangements are contemplated by and within the scope of the present invention.

Looking back to FIG. 1, in alternative embodiments, the user controls may be configured as wireless controls 17, in communication with the control circuitry via a radio frequency communication channel, an infrared (IR) communication channel, or other wireless communication means. In other embodiments, the user controls may comprise a motion sensor, an infrared sensor, a capacitive sensor, an ultrasonic sensor, a video sensor, a microwave sensor, or any combination of such sensors, with a user thus able to control one or more zones using gestures, such as swiping up or down to lighten or darken the tinting. In further embodiments, the user controls may be augmented by additional sensors or controls, such as scheduling software that sets a default tinting level based on the time of day or geographic location, or external light sensors that detect the intensity of sunlight outside of the aircraft to account for overcast or other low light conditions.

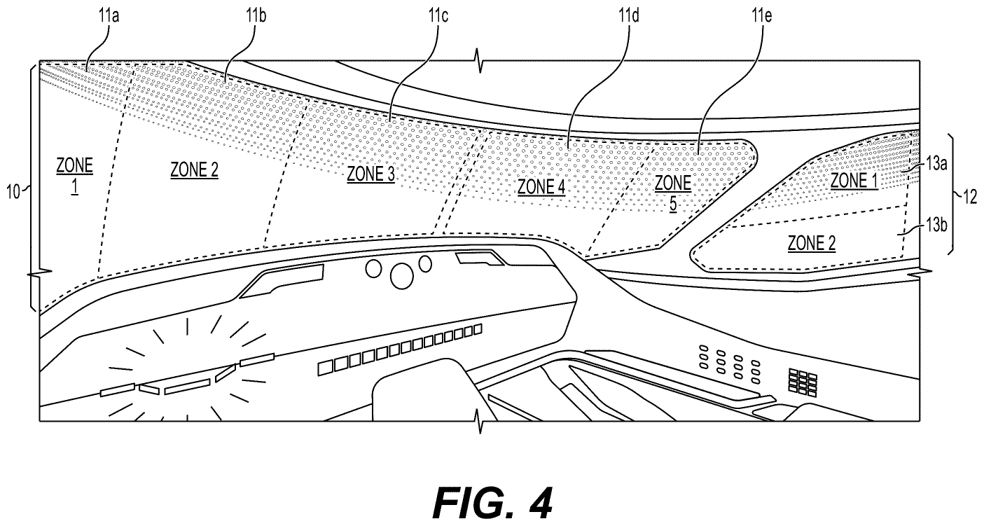

Turning to FIG. 4, the windscreen 10 and window 12 of FIGS. 2 and 3 is depicted with zones 11a, 11b, 11c, 11d, and 11e established on the windscreen 10 and zones 13a, 13b established on the window 12. Thus, it can be seen that the zones and controllers as described with respect to FIG. 1 may be implemented on an actual aircraft windscreen and window in accordance with the present invention.

It is to be understood that while certain forms of the present invention have been illustrated and described herein, it is not to be limited to the specific forms or arrangement of parts described and shown.

As described herein, it can be seen that the claimed invention is well-suited to provide adjustable gradient tinting for aircraft windscreens and windows.

1. An adjustable gradient tinting for an aircraft windscreen, comprising:
a windscreen comprising a contiguous transparent surface;
an electrochromic film attached to the windscreen, wherein the electrochromic film defines a plurality of zones on the windscreen; and
control circuitry operable to cause the electrochromic film to produce a semi-opaque gradient pattern such that the gradient pattern impedes the transmission of light through at least a portion of the windscreen.

2. The adjustable gradient tinting for an aircraft windscreen of claim 1, wherein the electrochromic film comprises: LCD technology, SPD technology, PDLC technology, or combinations thereof.

3. The adjustable gradient tinting for an aircraft windscreen of claim 1, wherein an opacity of the electrochromic film is adjusted by the control circuitry in response to a user input.

4. The adjustable gradient tinting for an aircraft windscreen of claim 3, wherein the user input comprises a user-operable control in communication with the control circuitry.

5. The adjustable gradient tinting for an aircraft windscreen of claim 4, wherein the user-operable control comprises a linear control, a rotary control, a sound actuated control, or combinations thereof.

6. The adjustable gradient tinting for an aircraft windscreen of claim 3, wherein the user input comprises a sensor operable to detect a gesture made by a user.

7. The adjustable gradient tinting for an aircraft windscreen of claim 5, wherein the sensor comprises an infrared sensor, a capacitive sensor, an ultrasonic sensor, a video sensor, a microwave sensor, or combinations thereof.

8. The adjustable gradient tinting for an aircraft windscreen of claim 1, further comprising one or more cockpit side windows, wherein the one or more cockpit side windows comprise an electrochromic film in communication with and controlled by the control circuitry.

9. The adjustable gradient tinting for an aircraft windscreen of claim 1, wherein the electrochromic film is embedded within the windscreen.

10. The adjustable gradient tinting for an aircraft windscreen, wherein the electrochromic film encompasses at least sixty percent of the windscreen.

11. The adjustable gradient tinting for an aircraft windscreen of claim 1, wherein the control circuitry includes driver circuitry operable to cause the electrochromic film to produce a semi-opaque gradient pattern such that the gradient pattern impedes the transmission of light through at least a portion of the windscreen.

12. The adjustable gradient tinting for an aircraft windscreen of claim 1, wherein the control circuitry comprises logic circuitry operable to limit the opacity of the electrochromic film.

13. The adjustable gradient tinting for an aircraft windscreen of claim 12, wherein limits to the opacity of the electrochromic film are user defined, predetermined, or combinations thereof.

14. An adjustable gradient tinting for an aircraft windscreen, comprising:
a windscreen comprising a transparent surface;
an electrochromic film attached to the windscreen and covering at least a portion of the transparent surface, wherein the electrochromic film defines at least one zone on the windscreen; and
control circuitry operable to cause the electrochromic film to produce a semi-opaque gradient pattern such that the gradient pattern impedes the transmission of light through at least a portion of the transparent surface.

15. The adjustable gradient tinting for an aircraft windscreen of claim 14, wherein the electrochromic film comprises: LCD technology, SPD technology, PDLC technology, or combinations thereof.

16. The adjustable gradient tinting for an aircraft windscreen of claim 1, wherein an opacity of the electrochromic film is adjusted by the control circuitry in response to a user-operable control in communication with the control circuitry.

17. The adjustable gradient tinting for an aircraft windscreen of claim 16, wherein the user-operable control comprises a linear control, a rotary control, a sound actuated control, a motion sensor, an infrared sensor, a capacitive sensor, an ultrasonic sensor, a video sensor, a microwave sensor, or combinations thereof.

18. The adjustable gradient tinting for an aircraft windscreen of claim 14, wherein the control circuitry includes driver circuitry operable to cause the electrochromic film to produce a semi-opaque gradient pattern such that the gradient pattern impedes the transmission of light through at least a portion of the windscreen.

19. The adjustable gradient tinting for an aircraft windscreen of claim 14, wherein the control circuitry comprises logic circuitry operable to limit the opacity of the electrochromic film.

20. The adjustable gradient tinting for an aircraft windscreen of claim 19, wherein limits to the opacity of the electrochromic film are user defined, predetermined, or combinations thereof.
